(19) United States
(12) Patent Application Publication
(10) Pub. No.: US 2016/0290512 A1
(43) Pub. Date: Oct. 6, 2016

(54) MECHANICAL SEAL ALIGNMENT ADJUSTMENT METHOD

(71) Applicants: Andrew Colverson, Rotherham (GB); Andrew Parkin, Rotherham (GB)

(72) Inventors: Andrew Colverson, Rotherham (GB); Andrew Parkin, Rotherham (GB)

(73) Assignee: AES Engineering Ltd., Rotherham (GB)

(21) Appl. No.: 15/086,550

(22) Filed: Mar. 31, 2016

(30) Foreign Application Priority Data
Mar. 31, 2015 (GB) 1505587.4

(51) Int. Cl. F16J 15/34

(52) U.S. Cl. CPC F16J 15/3472

(57) ABSTRACT

A mechanical seal for sealing between a housing and a relatively rotating shaft includes a gland for attachment to a housing for a piece of equipment, at least one adjustable setting in the ground and extending therefrom for engaging the housing and a non-permanent device for detachably attaching the gland to the housing for a piece of equipment.

### BACKGROUND OF THE INVENTION

1. Technical Field of the Invention

The present invention relates to mechanical seals, which may be used in all types of industries for separating a first liquid from a second liquid wherein the seal is cartridgized to aid correct installation.

2. Description of the Prior Art

Mechanical seals are commonplace in a multitude of industries for providing a seal between the pump interior and atmosphere. The seal is created by one sealing face rotating against a stationary sealing face. Commonly one of these faces is urged toward the other through the use of springs thus providing the required sealing force. The amount of spring force is optimized so that the operational life of the seal is as long as possible, while the volume of fluid that passes between the faces is kept to a minimum. The more fluid that passes between the faces means a longer operational life and, further, that emissions into the atmosphere and loss or contamination of potentially costly product fluid are increased. If virtually no fluid passes between the faces then the operational life will be shorter due to more of the face material being in contact, thereby generating more heat and reducing the length of time before the seal faces are degraded to a point where the leaked volume of fluid is no longer controlled. This is known as a seal failure.

The amount of spring force is controlled in seal designs by maintaining a consistent level of compression through maintaining the physical clearances between components during assembly and operation of the seal. This is commonly done through the use of setting clips which set the distance that the rotary components are spaced from the stationary components; however due to space or design constraints this is not always possible.

The requirement for the mechanical seals to be perpendicular with the rotating shaft of the equipment is important to ensure internal gaps and spring forces are consistent; this can determine the performance and longevity of the seal.

Applications where the equipment housing to which the mechanical seal fixes exist where the perpendicularity relationship between the seal gland bolting surface and the shaft is inconstant. In order for the seal to interact correctly with the shaft in these applications, alignment control must be possible, where the interaction of the mechanical seal with the equipment housing can be manipulated. This manipulation is required to create the perpendicular relationship that the seal requires with the shaft for optimum running conditions.

### SUMMARY OF THE INVENTION

According to the present invention, there is provided a mechanical seal for sealing between a housing and a relatively rotating shaft, the seal comprising;

(a) a gland attachable to the equipment housing;

(b) one or more adjustable setting in the gland and extending therefrom to engage the housing; and,

(c) non-permanent fixing means for detachably attaching the gland to the equipment housing.

Preferably, the setting members locate into orifices in the gland thereby controlling the displacement of the gland against the equipment and setting the perpendicular alignment.

More preferably, the setting members are threaded grub screws and the orifices that reside within, and are also threaded thereby, providing variable contact displacement between the equipment housing.

More preferably, the fixing members are threaded grubs screws that locate on the outer most surface of the setting members in the threaded orifices to secure them in place.

More preferably the setting members are flat point grub screws to maximize the contacting surface between the grub screws and the equipment housing.

Other objects and features of the present invention will become apparent when considered in combination with the accompanying drawing figures, which illustrate certain preferred embodiments of the present invention. It should, however, be noted that the accompanying drawing figures are intended to illustrate only select preferred embodiments of the claimed invention and are not intended as a means for defining the limits and scope of the invention.

BRIEF DESCRIPTION OF THE DRAWING FIGURES

In the drawing, wherein similar reference numerals and symbols denote similar features throughout the several views:

FIG. 1 shows a cross-sectional of a mechanical seal illustrating the current problem of potential gland misalignment;

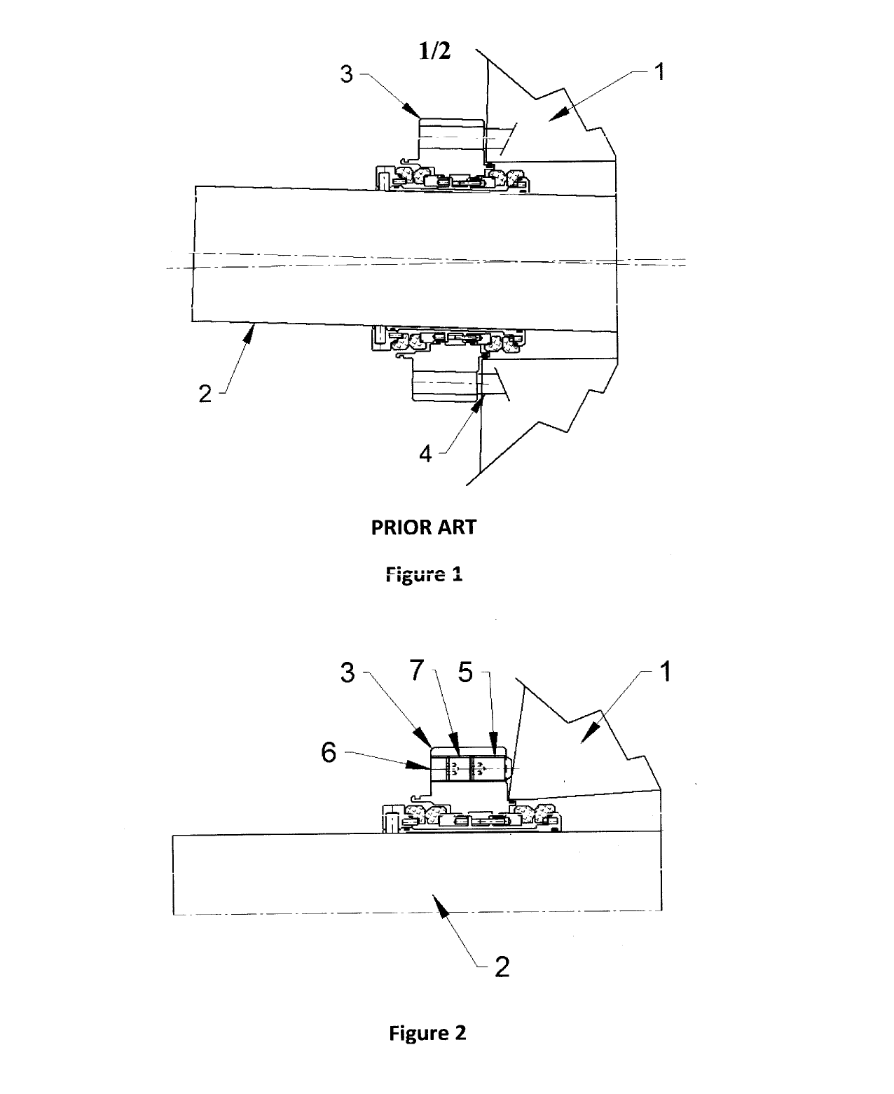

FIG. 2 shows a cross-sectional of a preferred embodiment of the present invention; and,

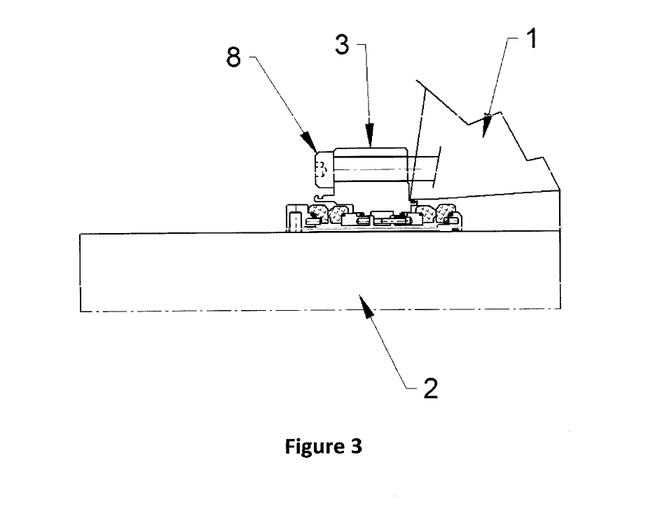

FIG. 3 shows a further cross section of the embodiment of FIG. 2 and showing the seal fixing arrangement.

### DETAILED DESCRIPTION OF THE DRAWING FIGURES AND PREFERRED EMBODIMENTS

The invention will now be described, by way of example only, with reference to the accompanying drawings:

The current problem, as shown in FIG. 1, exists where the equipment housing 1 is not perpendicular to the shaft 2. When the mechanical seal gland 3 is fixed to the equipment housing 1 using fixing members 4 it, in turn, is not perpendicular to the shaft causing non-concentric sealing faces.

A preferred embodiment of the present invention, as shown in FIG. 2, utilizes four settings or alignment members 5 to control the perpendicular relationship between the mechanical seal gland 3 and the equipments rotation shaft 2. The perpendicular relationship between the gland 3 and shaft 2 is controllable as the alignment members 5 can be variably displaced in the gland orifice 6. The alignment members 5 are flat point grub screws which typically occupy, when in position, about half the length of orifice 6. The described invention allows compensation for angular errors of the equipment housing that may cause a non-perpendicular relationship between the gland 3 and shaft 2.

Locking members 7, also in the form of grub screws, are introduced into orifices 6 and caused to bear against the ends of members 5. Members 7 provide a locking mechanism for preventing alignment members 5 from losing their set position and the set perpendicular relationship between gland 3 and shaft 2, which would overtime allow the seal to become loose or detached from the equipment housing and in turn cause the mechanical seal faces to run untrue.

As shown in FIG. 3, the preferred embodiment of the present invention where the gland 3 is non-permanently fixed to the equipment housing 1 uses four fixing members 8 after the perpendicular relationship between the gland 3 and shaft 2 is set.

While only several embodiments of the present invention have been shown and described, it will be obvious to those skilled in the art that many modifications may be made to the present invention without departing from the spirit and scope thereof.

What is claimed is:

1. A mechanical seal for sealing between a housing and a relatively rotating shaft, comprising:
a gland attachable to a housing for a piece of equipment;
means for adjustably setting in said gland and extending therefrom for engaging the housing; and,
non-permanent fixing means for detachably attaching said gland to the housing.

2. The mechanical seal for sealing between a housing and a relatively rotating shaft according to claim 1, wherein said means for adjustably setting in said gland is located in a threaded orifice in said gland.

3. The mechanical seal for sealing between a housing and a relatively rotating shaft according to claim 2, wherein said means for adjustably setting in said gland is threaded.

4. The mechanical seal for sealing between a housing and a relatively rotating shaft according to claim 2, further comprising additional non-permanent fixing means for detachably attaching said gland to said housing located in a same orifice as said means for adjustably setting in said gland for providing a locking mechanism.

5. The mechanical seal for sealing between a housing and a relatively rotating shaft according to claim 4, wherein said additional non-permanent fixing means has a threaded outer diameter engaging with a threaded orifice.

6. The mechanical seal for sealing between a housing and a relatively rotating shaft according to claim 1, wherein said means for adjustably setting in said gland include at least one grub screw for contacting the housing for a piece of equipment.
